(19) United States
(12) Patent Application Publication
(10) Pub. No.: US 2019/0005483 A1
(43) Pub. Date: Jan. 3, 2019

(54) PARKING COSTS IN VIRTUALLY PARTITIONED PARKING AREAS

(71) Applicant: Faraday&Future Inc., Gardena, CA (US)

(72) Inventors: Xiufeng Song, San Jose, CA (US); Carlos John Rosario, San Jose, CA (US)

(21) Appl. No.: 15/690,172

(22) Filed: Aug. 29, 2017

Related U.S. Application Data
(60) Provisional application No. 62/381,350, filed on Aug. 30, 2016.

(51) Int. Cl. G06Q 20/22; G08G 1/14

(52) U.S. Cl. CPC G06Q 20/22; G06Q 2240/00; G08G 1/146

(57) ABSTRACT

Methods, systems, and apparatuses to virtually partitioning a portion of a parking area for a vehicle based on at least one attribute of (a) the vehicle or (b) the parking area, determine a parking cost for the virtually partitioned portion of the parking area, obtain approval for the determined parking cost, and allocate the virtually partitioned portion of the parking area to the vehicle based on the obtained approval.

### CROSS-REFERENCE TO RELATED APPLICATIONS

This application claims the benefit of U.S. Provisional Application No. 62/381,350, filed Aug. 30, 2016, the entirety of which is hereby incorporated by reference.

### BACKGROUND

Aspects of the disclosure relate to determining parking costs in virtually partitioned parking areas. Currently, parking areas are divided, such as via painted partitioning lines, into a fixed number of parking spaces of predetermined size. Therefore, the number and size of parking spaces, as well as cost of parking in a parking area cannot be altered on demand to more efficiently accommodate a varying number of vehicles with varying sizes in the parking area. Exemplary embodiments of the disclosure address these problems, both individually and collectively.

### SUMMARY

Certain embodiments are described for determining parking costs in virtually partitioned parking areas. An exemplary embodiment includes an apparatus having at least one processor configured to virtually partitioning a portion of a parking area for a vehicle based on at least one attribute of (a) the vehicle or (b) the parking area; determine a parking cost for the virtually partitioned portion of the parking area, obtain approval for the determined parking cost, and allocate the virtually partitioned portion of the parking area to the vehicle based on the obtained approval; and a data storage unit configured to communicate with the processor and to store information on the parking cost.

Another exemplary embodiment includes an apparatus having a means for receiving at least one request for parking a vehicle in a parking area; means for means for virtually partitioning a portion of a parking area for a vehicle based on at least one attribute of (a) the vehicle or (b) the parking area; means for determining a parking cost for the virtually partitioned portion of the parking area; means for obtaining approval for the determined parking cost; and means for allocating the virtually partitioned portion of the parking area to the vehicle based on the obtained approval.

Another exemplary embodiment includes a method comprising virtually partitioning a portion of a parking area for a vehicle based on at least one attribute of (a) the vehicle or (b) the parking area; determining a parking cost for the virtually partitioned portion of the parking area; obtaining approval for the determined parking cost; and allocating the virtually partitioned portion of the parking area to the vehicle based on the obtained approval.

### BRIEF DESCRIPTION OF THE DRAWINGS

Aspects of the disclosure are illustrated by way of example. In the accompanying figures, like reference numbers indicate similar elements.

FIG. 1 illustrates an example environment in which various aspects of the disclosure can be implemented.

FIG. 2 includes a block diagram further illustrating various components for implementing aspects of the disclosure.

FIG. 3 illustrates exemplary operation flows of various aspects of the disclosure.

FIG. 4 in conjunction with FIGS. 1-3, further illustrates exemplary aspects of the disclosure.

FIG. 5 illustrates an exemplary display for implementing various aspects of the disclosure.

FIG. 6 illustrates further exemplary operation flows of various aspects of the disclosure.

FIG. 7 in conjunction with FIG. 6, further illustrates exemplary aspects of the disclosure.

### DETAILED DESCRIPTION

Examples are described herein in the context of determining parking costs in virtually partitioned parking areas. Embodiments provided in the following description are illustrative only and not intended to limit the scope of the present disclosure. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in any such actual implementation, numerous implementation-specific details may nevertheless exist in order to achieve goals such as compliance with application- and business-related constraints, and that these specific goals can vary from one implementation to another.

The term “virtual partitioning” as used throughout the specification refers to a partitioning that is not based on or relies on fixed markers defining dimensions of a partitioned portion, such as via painted partitioning lines defining a parking space in a parking lot, but rather to partitioning characterized by dimensions that can be altered on the fly based on the needs of the vehicle. The term “allocating the virtually partitioned portion” as used throughout the specification refers to assigning a virtually partitioned portion to a vehicle so as to make the allocated portion unavailable to other vehicles.

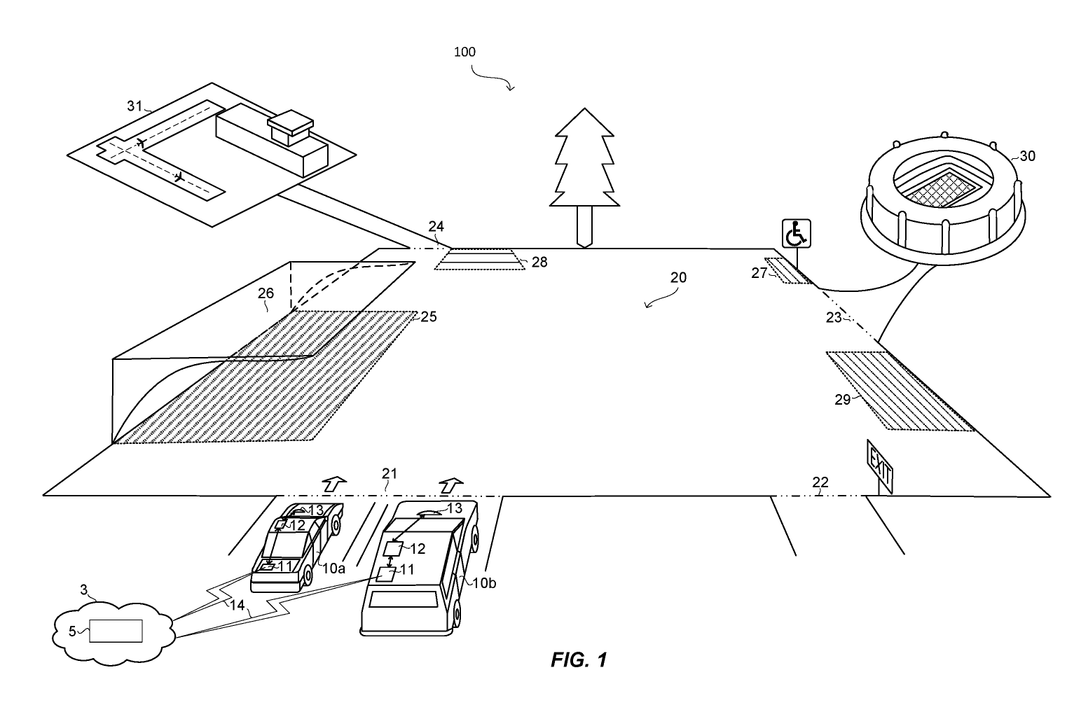

FIG. 1 illustrates an example environment 100 in which the various aspects of the disclosure can be implemented in the exemplary context of determining parking costs in an exemplary parking area 20. As shown in FIG. 1, parking area 20 has a number of attributes, such as a rectangular shape that is sized to accommodate a number of vehicles, such as vehicles 10a and 10b, vehicular entrance 21 and exit 22, and pedestrian access points 23 and 24 leading to respective venues 30 and 31, such as a sports arena and an airport, respectively. As shown in FIG. 1, parking area 20 may have portions of different attributes, such as covered region(s) 25 under covering structure(s) 26 (e.g. car port), handicap designation region(s) 27, and region(s) such as 28 and 29 in relative proximity to at least one of venues 30 or 31. As shown, region(s) may have multiple attributes, such as region(s) 27 having both a handicap designation and in relative proximity to pedestrian access points 23 for venue 30.

As described in greater detail below, parking spaces in parking area 20 have virtually configured perimeters. As such, parking area 20 either does not have predetermined, fixed partitioning markings (e.g. via painted partitioning lines) to define its parking spaces, or such fixed partitioning markings are not used by the implementations described in this disclosure in determining parking space(s) for vehicle(s) in parking area 20.

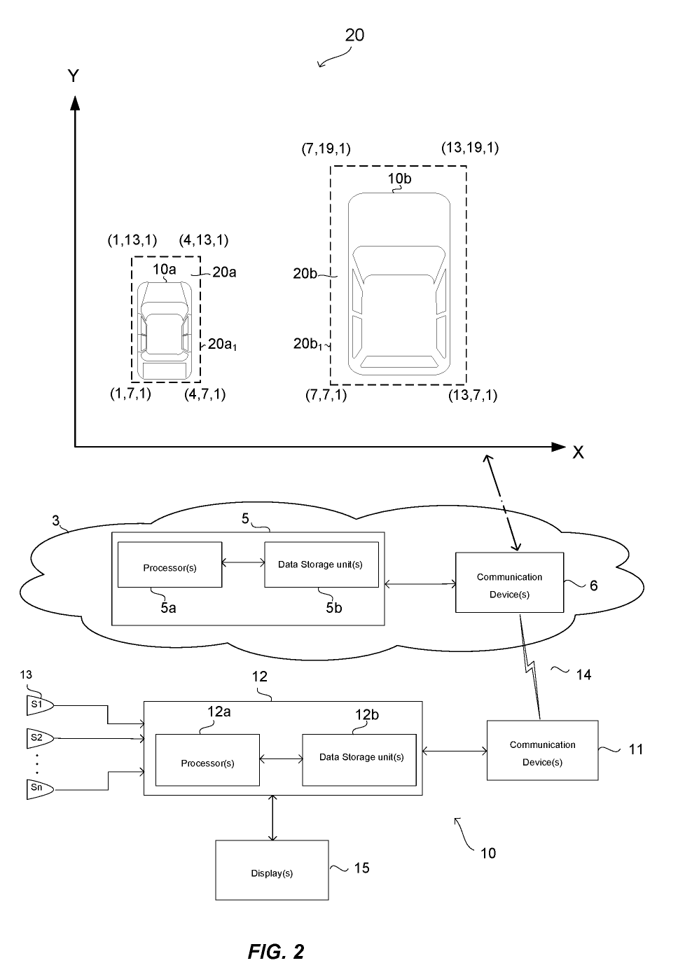

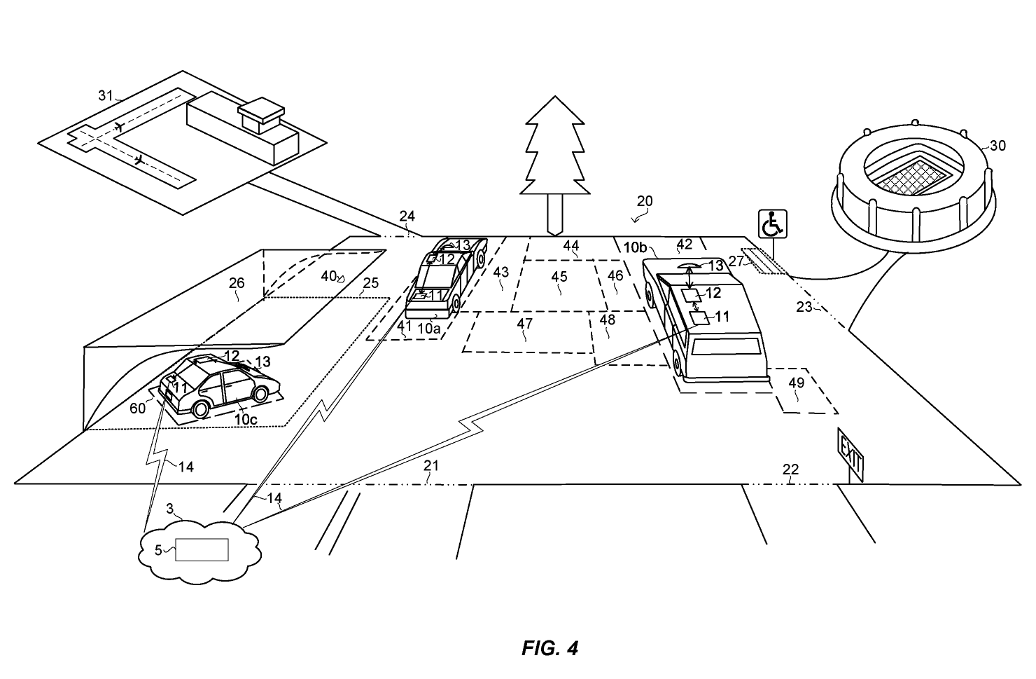

FIG. 2 includes block diagrams which, in conjunction with FIG. 1, further illustrate the operations and various components for implementing aspects of the disclosure. As shown in FIG. 2, exemplary vehicle(s) 10, such as vehicle 10a or 10b, include parking system(s) 12 which include processor(s) 12a and data storage unit(s) 12b. Parking system(s) 12, housed within vehicle(s) 10, may receive data, such as parking or navigation data from sensors(s) 13, as described below and in greater detail in conjunction with FIGS. 4-6. In an exemplary embodiment, display unit(s) 15, such as interactive display unit(s), are in communication with parking system(s) 12 and are configured to provide and/or receive visual and/or audio data to and from a driver of vehicle 10 as described below and in greater detail in conjunction with FIGS. 4-6.

In an exemplary embodiment, vehicle(s) 10 are configured to communicate via communication device(s) 11, such as by wireless means 14, with communication device(s) 6 on a remote server 5, such as one residing in a data cloud 3. Remote server 5 includes processor(s) 5a and data storage unit(s) 5b. Processor(s) 5a is configured to virtually partition portion(s), such as portions 20a or 20b, of parking area 20 based at least one attribute of (a) vehicles 10a or 10b and/or (b) attributes of parking area 20. Data storage unit(s) 5b, coupled to processor(s) 5a, are configured to store information, such as attributes of vehicle 10a, or parking area 20, and virtually partitioned portion(s) such as 20a or 20b. In an exemplary embodiment, the dimensions and other pertinent attribute(s) of the vehicle(s) are obtained from database(s), such as a look-up table(s), containing information, such as the make, model, year, etc., of the vehicle(s).

In remote server 5, processor(s) 5a define virtual perimeter(s) of partitioned portion(s), such as perimeters 20a₁ and 20b₁ (illustrated as dashed-lines), which define portions 20a and 20b respectively, as shown in FIG. 2.

As shown in FIG. 2, in one embodiment, each of virtual perimeters 20a₁ and 20b₁, or their respective portions 20a and 20b, may be represented in various ways. As one example, a rectangular perimeter may be defined by four corner points, each corresponding to a set of (x, y, z) coordinates in a Cartesian coordinate system. Thus, perimeter 20a₁ may be represented by the four corners (x=1, y=7, z=1), (x=1, y=13, z=1), (x=4, y=13, z=1), and (x=4, y=7, z=1). Other perimeters, such as 20b₁, may be similarly represented, as shown in FIG. 2. For simplicity, the Z-axis used for parking area's elevation, including different levels of a multi-level parking area, is not shown in the “bird's eye” view of FIG. 2.

In an exemplary embodiment, after virtually partitioning portion(s) 20a and 20b of parking area 20 for vehicles 10a and 10b as described above, processor(s) 5a may determine parking cost(s) for virtually partitioned portion(s) of parking area 20, such as portions 20a and 20b, for each of vehicles 10a and 10b, as shown in FIG. 2. As described below in greater detail, processor(s) 5a virtually partitions portion(s), such as portions 20a or 20b, based on dimensions of vehicle(s) 10, such as vehicles 10a or 10b. In exemplary embodiment of FIG. 2, vehicle 10b has larger dimensions than vehicle 10a, and therefore processor(s) 5a may virtually partition a portion 20b that is correspondingly larger in area than virtually partitioned portion 20a for smaller vehicle 10a. Correspondingly, processor(s) 5a may determine a higher parking cost for portion 20b than portion 20a. In this way, some or all of parking area 20 can be virtually configured to parking spaces of different sizes, and varying parking costs can be offered, based on different dimensions of vehicle(s) 10. As described below in greater detail, processor(s) 5a is configured to obtain approval(s) for determined parking cost(s), and allocate virtually partitioned portion(s), such as portions 20a or 20b, to vehicle(s) 10, such as vehicles 10a or 10b based on the obtained approval(s) to accept the terms offered, including the parking cost.

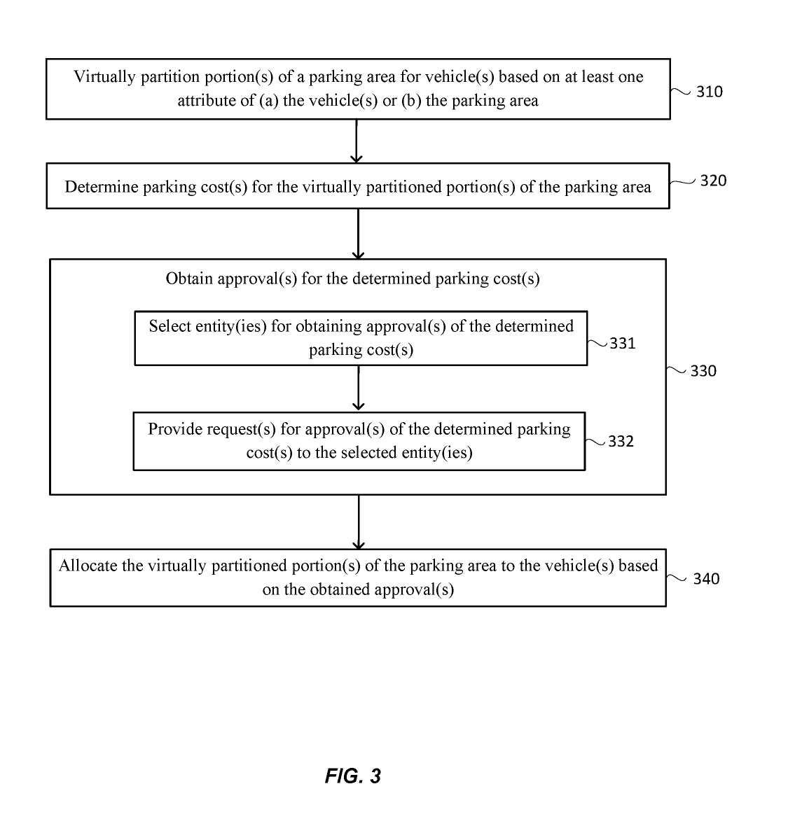

FIG. 3, in conjunction with FIG. 4, illustrates an exemplary operation flow of various aspects of the disclosure. Starting in block 310, processor(s) 5a in remote server 5 virtually partition portions 41 and 42 (discussed later in reference to FIG. 4) of parking area 20 based on dimensions of each vehicle 10a and 10b, as previously described in conjunction with FIG. 2. In an exemplary embodiment, virtually partitioning portion(s) of parking area 20 is based on parking profile(s) associated with vehicle 10a. Parking profile(s) may include information on parking preferences, such as covered parking, proximity to a venue, etc., as well as dimensions and other attributes of vehicle 10a or its driver.

In an exemplary embodiment, processor(s) 5a first receive request(s) for parking vehicles 10a or 10b in parking area 20, which are at entrance 21 of parking area 20, as shown in FIG. 4. Request(s) can be received directly from vehicles 10a and 10b (as shown), indirectly via parking station(s) relay(s) (not shown), or by other means.

As shown in FIG. 4, virtually partitioned portions 41 and 42 are of different sizes based on corresponding different dimensions of their respective vehicles 10a and 10b, and so as illustrated, virtually partition portion 41 is substantially smaller than virtually partition portion 42.

Processor(s) 5a may also determine a location within parking area 20 for virtually partitioned portions 41 and 42, based on attributes of parking area 20, such as covered region(s) 25 under covering structure(s) 26 (e.g. car port), or handicap designation region(s) 27. In the exemplary embodiment shown in FIG. 4, location of virtually partitioned portion 41 is selected to be in proximity of access point 24 for airport venue 31. The determination can be made based on available information such as an indication that a present or future occupant of vehicle 10a is travelling to or returning from airport venue 31. Likewise for vehicle 10b, location of virtually partitioned portion 42 is selected to be in proximity of access point 23 for sports arena venue 30. In another example, a nature of activity within sports arena venue 30, such as approximated duration time for a sporting event based on the sport being played (e.g. football games, track and field competitions, etc.) may influence the determination on how to virtually partition parking area 20 and locate portions for each parked vehicle.

Parking area 20 may further be virtually partitioned to more portion(s), such as portions 43 through 49, as shown in FIG. 4. For simplicity of illustration, portion(s) 43 through 49 are shown as adjacent and rectangular in shape, although it is contemplated to be within the scope of the present disclosure that parking area 20 can be virtually partitioned into variety of shapes and sizes, such as oval, triangular, etc, as well as a variety of configurations for locations of virtually partitioned portion(s) and access routes. In this way, parking area 20 can be virtually reconfigured as needed, such as based on a nature of activity within one or more of its serviced venues, such as venues 30 or 31. Therefore, number, size and location of parking spaces in parking area 20 can be altered as need arises to more efficiently accommodate a varying number of vehicles 10 with varying sizes in parking area 20.

Next, in block 320, processor(s) 5a determine a parking cost(s) for virtually partitioned portion(s) 41 and 42 of parking area 20. Parking cost(s) may vary based on attributes corresponding to at least one attribute of (a) vehicles 10a or 10b and/or (b) attributes of parking area 20. For example, a higher parking cost might be determined for vehicle 10b than for vehicle 10a, based on larger size of vehicle 10b which requires a correspondingly larger virtually partitioned portion 42. Likewise, attributes of parking area 20, such as covered region(s) 25 under covering structure(s) 26 (e.g. car port), may affect parking cost(s) determination. For example, a higher parking cost might be determined for a virtually partitioned portion within covered region(s) 25, such as portion 60, or in relative proximity to at least one of venues 30 or 31, such as within portion(s) 41 and 42. Other factors, such as duration of stay (e.g. based on retrieval time of vehicle 10 from parking area 20), may also be considered in varying parking cost(s).

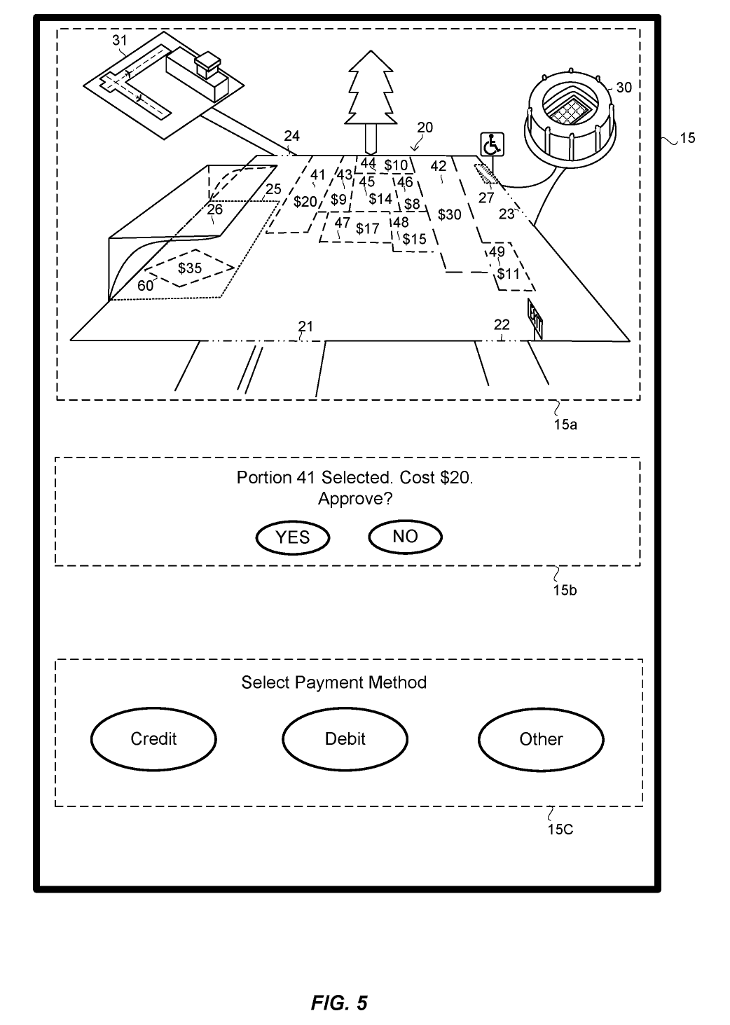

Next, in block 330, approval(s) is obtained for determined parking cost(s) for virtually partitioned portion(s), such as portions 41, 42, and 60. In an exemplary embodiment as shown in blocks 331 and 332, entity(ies) are selected for obtaining approval(s) of determined parking cost(s), such one entity for each of vehicles 10a, 10b or 10c. For example in block 331, an entity might be selected from at least one of (a) vehicle, such as processor(s) 12a in each vehicle, (b) an occupant of vehicle, such as driver or a passenger, or (c) at least one pre-assigned entity, such as a charge account associated with vehicle or its occupant(s). Next, in block 332, request(s) are provided to the selected entity(ies) for approval(s) of determined parking cost(s). In exemplary embodiment, requests maybe provided wirelessly, such via Wifi, or cellular communication, and in various forms, such an payments application or text message notifications, and may appear graphically on a display module 15, as described in greater detail below in conjunction with FIG. 5.

Next, in block 340, upon obtaining of approvals of determined parking costs, virtually partitioned portions 41, 42, and 60 are allocated to their respective vehicles 10a, 10b, and 10c, which may then park in their allocated portions, as shown in FIG. 4.

In another exemplary embodiment, sensor(s) 40 may also be placed at location(s) within sensing range of parking area 20 (such as atop a covering structure 26), so provide remote server 5 with additional information, such as traffic dynamics within parking area 20, and availability of any unoccupied portion(s) in parking area 20.

FIG. 5 shows an exemplary embodiment in which determined parking cost information are graphically displayed by processor(s) 12a on a visualization module, such as display unit 15, of a vehicle 10. As shown in FIG. 5, an exemplary graphical representation of parking area 20 is displayed on a portion 15a, as well as available virtually partitioned portions, such as 41-49, and 60. A determined parking cost for each of portions 41-49, and 60 are displayed, such as within graphical perimeter of each portion, as shown in FIG. 5. As previously described above, parking cost of a portion can be based on a number of attributes of vehicle 10, or parking area 20. For example, determined parking cost for virtually partitioned portion 60 may be $35, or $21 more than determined parking cost for portion 45 (which is only $14) due to portion 60 being located in covered region(s) 25. Likewise, at $20, determined parking cost of portion 41 may also be more than portion 45 due to closer proximity of portion 41 to entrance 24 to venue 31.

In an exemplary embodiment, a user may be allowed to select a portion, such as portion 42, of substantially larger dimensions than the user's vehicle 10, so to reduce the risk of a vehicle 10 coming into adverse contact, such as being hit by opened car doors, from other vehicle(s) parked in proximity of portion 42, such as portions 44, 46 and 48. A higher parking cost (e.g. $30), may be determined based on the larger dimensions of portion 42.

In an exemplary embodiment, virtually partitioning portion(s) of parking area 20 may be also based on parking profile(s) associated with vehicle(s) 10. A parking profile may include information on parking preferences, such as covered parking, location(s) close to a venue, etc, and well as dimensions and other attributes of vehicle(s) 10 or its occupant(s).

A user, such as a driver or passenger(s) in a vehicle 10, may then select a desired portion, such as portion 41, from provided portions, such as 41-49, and 60. In an exemplary embodiment, display unit 15 is an interactive unit, such as a touch screen, by which a user can select a desired portion by touching the graphically represented area corresponding to a desired portion, such as portion 41.

Following user's selection, user is then presented by processor(s) 12a with a confirmation notification of selected portion and associated determined parking cost, and queried to either approve or deny the selection and determined parking cost, as shown in portion 15b. Upon obtaining approval of user's selection by processor(s) 12a, user is then presented, in portion 15c, with payment options, such as credit, debit or other options including crypto currencies, or a pre-assigned entity such as a corporate or personal parking charge account. Processor(s) 12a then provides, such as to remote server 5, payment or payment information for determined parking cost based on selected payment option.

According to one embodiment, each of portions 15a, 15b and 15c may occupy some or all of display unit 15 during a given time. It should also be noted that the interactive illustration in FIG. 5 as a whole is exemplary only, and other display methods, such as textual, alpha-numeric, different graphics, etc. can also be used to interact with a user, and are contemplated to be within the scope of the disclosure.

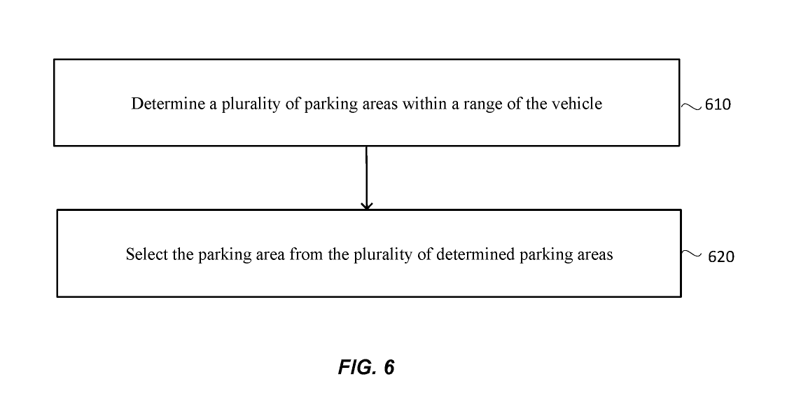

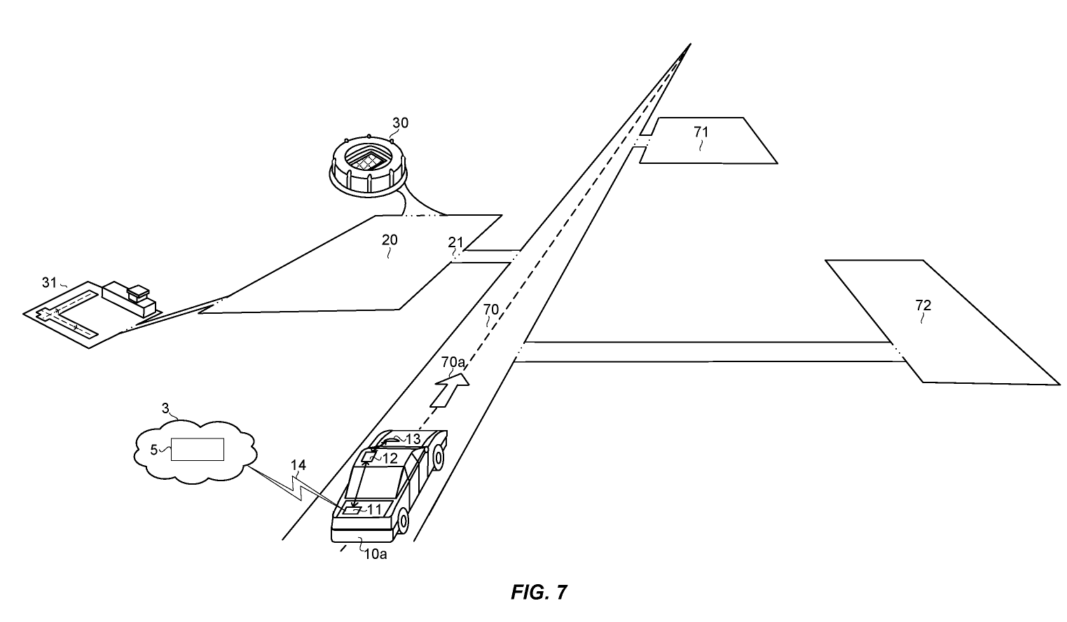

FIG. 6, in conjunction with FIG. 7, illustrates further exemplary operation flows of various aspects of the disclosure. Starting in block 610, it is determined (e.g. by parking system(s) 12 or remote server 5) that vehicle 10a travelling along route 70 in direction of arrow 70a, is within range of parking areas, such as parking areas 20, 71 and 72. In an exemplary embodiment, processor(s) 12a is configured to display to a user (e.g. on display unit 15) characteristics and features of parking areas 20, 71 and 72, such as their proximity to route 70, venues 30 or 31, and parking area(s)′ virtually partitioning capabilities.

Next, in block 620, a parking area, such as parking area 20 is selected, such as by user, from determined parking areas 20, 71 and 72. In an exemplary embodiment, a parking area may be selected based on virtually partitioning capabilities of parking area, as well as other available information such as (1) time of day, (2) average speed of getting vehicles in and out of parking area, (3) users' ranking of ease of getting in and out of that parking area (such as from a canonical database), (4) types of vehicle(s) parked (e.g. trucks, SUVs, motor-cycles, etc.), (5) anticipated duration stay of vehicle(s) parked in parking area, or (6) status offering, such as VIP, handicap, etc.

It is understood that specific order or hierarchy of steps in the processes is an illustration of exemplary approaches. Based upon design preferences, it is understood that the specific order or hierarchy of steps in the processes may be rearranged. Further, some steps may be combined or omitted. The accompanying method claims recite various steps in a sample order. Unless otherwise specified, the order in which the steps are recited is not meant to require a particular order in which the steps must be executed.

The previous description is provided to enable any person skilled in the art to practice the various aspects described herein. Various modifications to these aspects will be readily apparent to those skilled in the art, and the generic principles defined herein may be applied to other aspects.

Operations described in the present disclosure may be controlled and/or facilitated by software, hardware, or a combination of software and hardware. Operations described in the present disclosure may be controlled and/or facilitated by software executing on various machines, such as in the above-described remote server 5, vehicle(s) 10, or an on-site server (not shown), or any combination thereof. Such operations may also be controlled and/or facilitated specifically-configured hardware, such as field-programmable gate array (FPGA) specifically configured to execute the various steps of particular method(s). For example, relevant operations can be implemented in digital electronic circuitry, or in computer hardware, firmware, software, or in a combination thereof. In one example, a device may include a processor or processors. The processor may be coupled to a computer-readable medium, such as a random access memory (RAM). The processor may execute computer-executable program instructions stored in memory, such as executing one or more computer programs. Such processors may comprise a microprocessor, a digital signal processor (DSP), an application-specific integrated circuit (ASIC), field programmable gate arrays (FPGAs), and/or state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, optical media, magnetic tape or other magnetic media, and/or any other medium from which a computer processor can read. The processor, and the processing, described may be in one or more structures, and may be dispersed through one or more structures. The processor may comprise code for carrying out one or more of the methods (or parts of methods) described herein.

The foregoing description has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

What is claimed is:

1. A method, comprising:
virtually partitioning a portion of a parking area for a vehicle based on at least one attribute of (a) the vehicle or (b) the parking area;
determining a parking cost for the virtually partitioned portion of the parking area;
obtaining approval for the determined parking cost; and
allocating the virtually partitioned portion of the parking area to the vehicle based on the obtained approval.

2. The method of claim 1, wherein at least one attribute of the vehicle includes dimensions of the vehicle.

3. The method of claim 1, wherein determining the parking cost is further based on an event.

4. The method of claim 1, wherein the virtually partitioning comprises virtually partitioning a plurality of portions of the parking area, wherein each portion is virtually partitioned based on at least one of (a) dimensions of a corresponding vehicle in a plurality of vehicles or (b) attributes of the parking area.

5. The method of claim 1, wherein the attributes of the parking area comprise at least one of (a) a size of the parking area, (b) a shape of the parking area, (c) a proximity of different portions of the parking area to a venue, (d) a covered area within the parking area, (e) a nature of activity within the venue, or (f) a retrieval time of the vehicle from the parking area.

6. The method of claim 1, wherein the virtually partitioning a portion of a parking area is based on a parking profile associated with the vehicle.

7. The method of claim 1, wherein the obtaining approval further comprising:
selecting an entity for obtaining approval of the determined parking cost; and
providing a request for approval of the determined parking cost to the selected entity.

8. The method of claim 7, wherein the entity is selected from at least one of (a) the vehicle, (b) at least one occupant of the vehicle, or (c) at least one pre-assigned entity.

9. The method of claim 1, further comprising:
determining a plurality of parking areas within a range of the vehicle; and
selecting the parking area from the plurality of determined parking areas.

10. The method of claim 9, wherein selecting the parking area from the plurality of parking areas is based on the virtually partitioning capabilities of the parking areas.

11. The method of claim 1, the virtually partitioning further comprising:
defining a virtual perimeter of the partitioned portion.

12. An apparatus, comprising:
at least one processor configured to virtually partitioning a portion of a parking area for a vehicle based on at least one attribute of (a) the vehicle or (b) the parking area; determine a parking cost for the virtually partitioned portion of the parking area, obtain approval for the determined parking cost, and allocate the virtually partitioned portion of the parking area to the vehicle based on the obtained approval; and
a data storage unit configured to communicate with the processor and to store information on the parking cost.

13. The apparatus of claim 12, the at least one processor is further configured to define a virtual perimeter of the partitioned portion and to allocate the virtually partitioned portion of the parking area to the vehicle.

14. The apparatus of claim 12, the at least one processor is further configured to select a parking area from a plurality of parking areas.

15. The apparatus of claim 14, further comprising a display module configured to display a plurality of parking areas to a user wherein the parking area is selected from the plurality of parking areas.

16. The apparatus of claim 12, wherein the at least one processor is configured to virtually partition a plurality of portions of the parking area, wherein each portion is virtually partitioned based on at least one of (a) dimensions of a corresponding vehicle in a plurality of vehicles or (b) attributes of the parking area.

17. The apparatus of claim 12, further comprising a display module configured to display the determined parking cost.

18. The apparatus of claim 12, wherein the at least one processor is further configured to provide payment for the determined parking cost based on a selected payment option.

19. An apparatus, comprising:
means for virtually partitioning a portion of a parking area for a vehicle based on at least one attribute of (a) the vehicle or (b) the parking area;
means for determining a parking cost for the virtually partitioned portion of the parking area;
means for obtaining approval for the determined parking cost; and
means for allocating the virtually partitioned portion of the parking area to the vehicle based on the obtained approval.

20. The apparatus of claim 19, further comprising:
means for selecting the parking area from a plurality of parking areas based on the virtually partitioning capabilities of the parking areas.
